(19) United States
(12) Patent Application Publication
(10) Pub. No.: US 2006/0110555 A1
(43) Pub. Date: May 25, 2006

(54) Synthetic resin container with excellent functional characteristic, and production method therefor

(75) Inventors: Nao Asai, Koto-ku (JP); Masato Suzuki, Isehara-City (JP); Daisuke Uesugi, Matsudo-City (JP)

Correspondence Address: OLIFF & BERRIDGE, PLC, P.O. BOX 19928, ALEXANDRIA, VA, 22320, US

(73) Assignee: YOSHINO KOGYOSHO CO., LTD., KOTO-KU (JP)

(21) Appl. No.: 10/516,073

(22) PCT Filed: Jun. 5, 2002
(86) PCT No.: PCT/JP02/05561

§ 371 Date: Nov. 29, 2004

(51) Int. Cl. B32B 27/08; B32B 1/08

(52) U.S. Cl. 428/35.7

(57) ABSTRACT

A synthetic resin container having an excellent heat resistance and an improved gas barrier property, as well as production method therefor. The container has a matrix that is blended with a gas barrier material, and is produced by a process including bi-axial stretch blow molding steps performed at least twice, with a heat treatment step therebetween.

### BACKGROUND ART

1. Field of the Invention

The present invention relates to a synthetic resin container capable of suppressing degradation in quality of the contents due to permeation of oxygen, carbon dioxide gas or the like through the container, while providing improved heat resistance, and also to a method for producing such container.

2. Prior Art

Synthetic resin container as represented by PET bottles are recently used widely, as containers for food, beverages, cosmetics or chemicals, since such containers are light in weight and easy to handle, and are capable of preserving transparency to exhibit an appearance comparable to glass containers, besides that they can be produced at low cost.

On the other hand, synthetic resin containers suffer from a problem that, due to inevitable permeation of oxygen or carbon dioxide gas through the container main body, the so-called shelf life (i.e., the period in which the quality of the contents can be guaranteed) is relatively short as compared to glass containers.

Moreover, this type of container has a poor heat resistance, as exemplified by an upper limit temperature of 85-87° C. in the case of polyethylene terephthalate resin container. Particularly when a hot liquid at a temperature higher than such upper limit temperature is filled as the contents, shape deformation occurs due to thermal shrinkage. Thus, there is a limitation against expanding the scope of application.

### DISCLOSURE OF THE INVENTION

It is therefore an object of the present invention to provide a novel container capable of eliminating the above-mentioned problems of the conventional synthetic resin container, as well as a production method therefor.

According to one aspect of the present invention, there is provided a synthetic resin container having excellent gas barrier property and heat resistance, wherein said container comprises a matrix that is blended with a gas barrier material, and wherein said container is produced by a process including bi-axial stretch blow molding steps performed at least twice, with a heat treatment step therebetween.

In the container having the above-mentioned structure, it is preferred that the matrix comprises polyethylene terephthalate resin, and the gas barrier material comprises at least one member selected from a group consisting of a methaxylylene group-containing polyamide resin, an amorphous polyester resin and an ethylene naphthalate-ethylene terephthalate copolymer resin.

According to another aspect of the present invention, there is provided a multi-layered synthetic resin container having excellent gas barrier property and heat resistance, wherein said container comprises a base layer having a matrix that is blended with a gas barrier material, and a protection layer having an enriched gas barrier property, and wherein said container is produced by a process including bi-axial stretch blow molding steps performed at least twice, with a heat treatment step therebetween. In this instance also, it is preferred that the matrix comprises polyethylene terephthalate resin, and the gas barrier material comprises at least one member selected from a group consisting of a methaxylylene group-containing polyamide resin, an amorphous polyester resin and an ethylene naphthalate-ethylene terephthalate copolymer resin.

The protection layer may comprise at least one member selected from a group consisting of a methaxylylene group-containing polyamide resin, an amorphous polyester resin, an ethylene naphthalate-ethylene terephthalate copolymer resin and an ethylene-vinyl alcohol copolymer resin.

According to still another aspect of the present invention, there is provided a method for producing a synthetic resin container having excellent gas barrier property and heat resistance, by bi-axial stretch blow molding steps performed at least twice, with a heat treatment step therebetween, wherein said blow molding steps are performed with a preform consisting of a synthetic resin of which a matrix is blended with a gas barrier material.

The preform may comprise a multi-layered structural body comprising a base layer having a matrix that is blended with a gas barrier material, and a protection layer having an enriched gas barrier property.

### BRIEF DESCRIPTION OF THE DRAWINGS

The present invention will be more fully described below with reference to the accompanying drawings.

FIG. 1 is a schematic view showing the structure of the container according to the present invention.

FIG. 2 is a view showing a preform that can be suitably used in the present invention.

FIGS. 3a through 3d show the appearance of the shaped body in various process steps of the blow molding.

FIGS. 4a and 4b are fragmentary enlarged views showing the multi-layered structure of the container according to the present invention.

FIGS. 5a through 5c are side view, plan view and bottom view, respectively, of the container according to the illustrated embodiment.

### BEST MODE FOR CARRYING OUT THE INVENTION

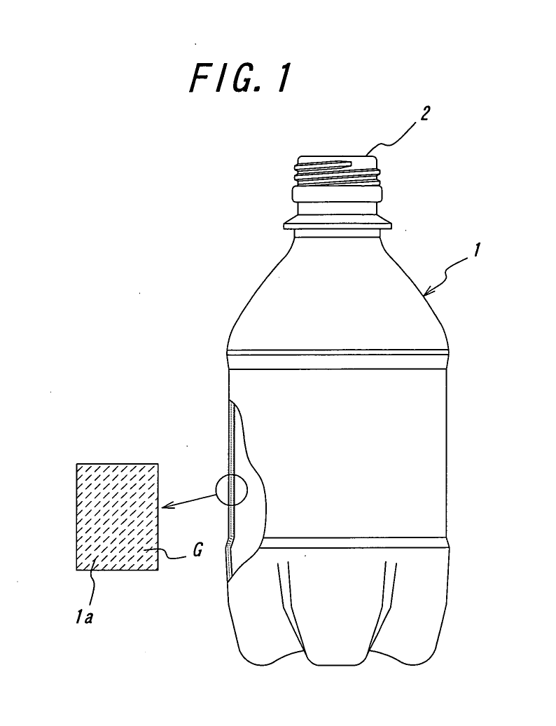

FIG. 1 schematically shows the appearance of the synthetic resin container according to the present invention, having a capacity of 500 ml, and excellent heat resistance and pressure resistance, wherein reference numeral 1 denotes a container main body, and 2 a mouth portion provided integrally for the container main body.

According to the present invention, when polyethelene terephthalate resin is used as a matrix 1a, a gas barrier material is blended into the resin in order to suppress permeation of oxygen or the like and thereby provide an improved gas barrier property.

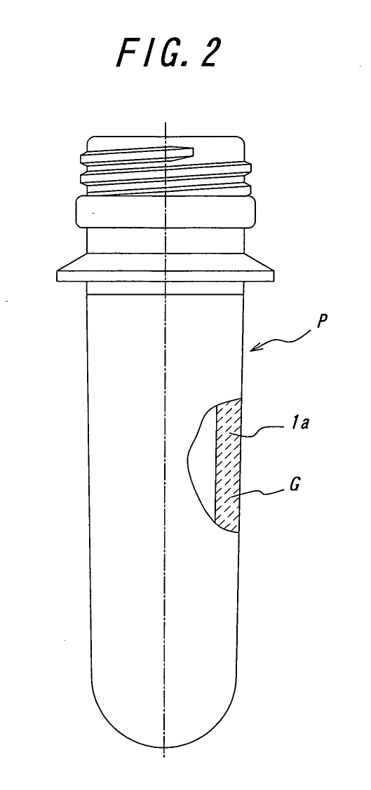

In order to produce such a container, a preform P as shown in FIG. 2 is used, which is obtained by injection molding or extrusion molding of a raw material in which a gas barrier material is blended into the base phase 1a, and of which the mouth portion is subjected to crystallization (i.e., whitening). This preform is heated to a temperature under which stretching effect is expressed, e.g., 70-130° C., more preferably 90-120° C., and then subjected to a primary bi-axial stretching blow molding under the temperature of 50-230° C., more preferably 70-180° C., and stretched surface area ratio of 4-22 times (more preferably 6-15 times, to realize an oversize of 1.2-2.5 times in capacity as compared to the finished product). Subsequently, the so-obtained blow molded body is heat treated under a temperature of 110-255° C., more preferably 130-200° C., to cause a forced shrinkage to the length of 0.60 to 0.95 times of the finished product, in order to relieve the internal residual stresses, and subjected to a secondary blow molding under the temperature of 60-170° C., more preferably 80-150° C.

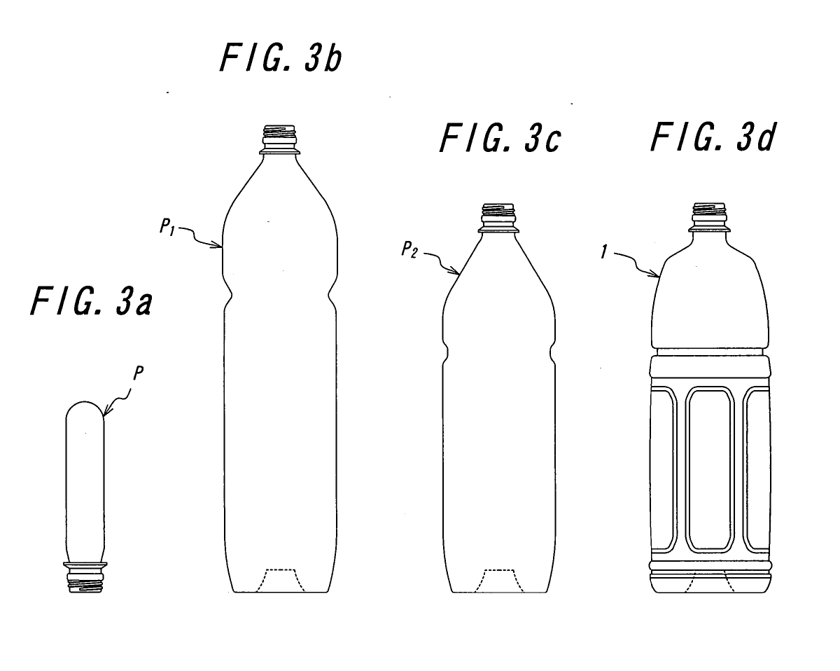

FIGS. 3a through 3d show the appearance of the shaped body in various process steps of the blow molding, from the state of preform to the finished heat-resistant container having a capacity of 1.5 litters, wherein P₁ denotes a primary blow molded body, and P₂ denotes the primary blow molded body after the heat treatment.

As described above, the container produced by blow moldings performed at least twice with a heat treatment therebetween has an excellent strength against external heat (improved heat resistance) and improved gas barrier performance, since the residual stresses in the main body portion are significantly relieved and the density of the resin becomes higher.

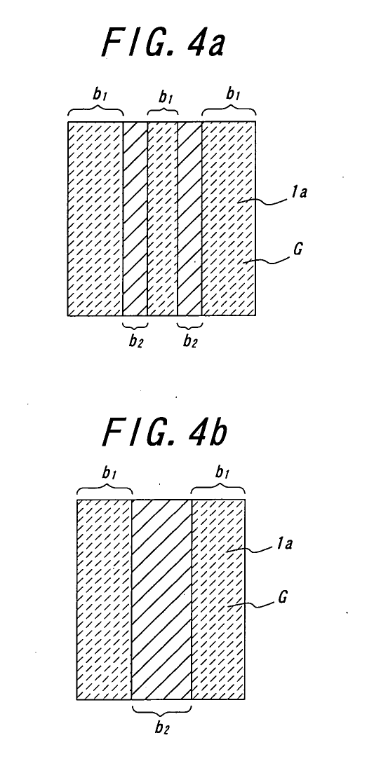

FIGS. 4a and 4b show further embodiments of the container according to the present invention, illustrating the multi-layered structure in enlarged scale. It can be seen that the base layer b₁ in which the matrix 1a is blended with a gas barrier material G, and the protection layer b₂ having an enriched gas barrier property may be alternately superimposed with each other to obtain a desired multi-layer structure (two-types three-layers, two-types five-layers, etc.). In this instance, it is possible to further prolong the shelf life of the merchandise, as a result of significant improvement in the gas barrier property.

The multi-layered container as shown in FIGS. 4a and 4b can be produced by using a correspondingly multi-layered preform. While the present invention has been explained with reference to two-types three-layers and two-types five-layers, the multi-layered structure is not limited to these embodiments and may be subject to changes depending upon the use applications of the container.

Besides the above-mentioned polyethylene terephthalate, the resin forming the matrix 1a may comprise a saturated polyester group thermoplastic synthetic resin, such as polybuthylene terephthalate or polyethylene naphthalate.

The barrier material that can be suitably blended into the matrix 1a may comprise a methaxylylene group-containing polyamide resin, such as poly-m-xylylene adipamide (sold by Mitsubishi Gas Chemical Co., Ltd., as “MXD-6”), besides an amorphous polyester resin, such as a copolymer of terephthalic acid, isophthalic acid, ethylene glycol, other diol component or the like, or an ethylene naphthalate-ethylene terephthalate copolymer resin (EVOH).

As for the blend ratio of the barrier material, when moldability is taken into consideration, it is preferred that the blend ratio is within the range of 0.5-10 mass %, preferably 7 mass % at the highest. Also, when recycling is taken into consideration, it is preferred that the blend ratio is less than 5 mass %.

The protection layer b₂ may comprise a methaxylylene group-containing polyamide resin, an amorphous polyester resin, an ethylene naphthalate-ethylene terephthalate copolymer resin, an ethylene-vinyl alcohol copolymer resin (EVOH), or the like.

### EMBODIMENT

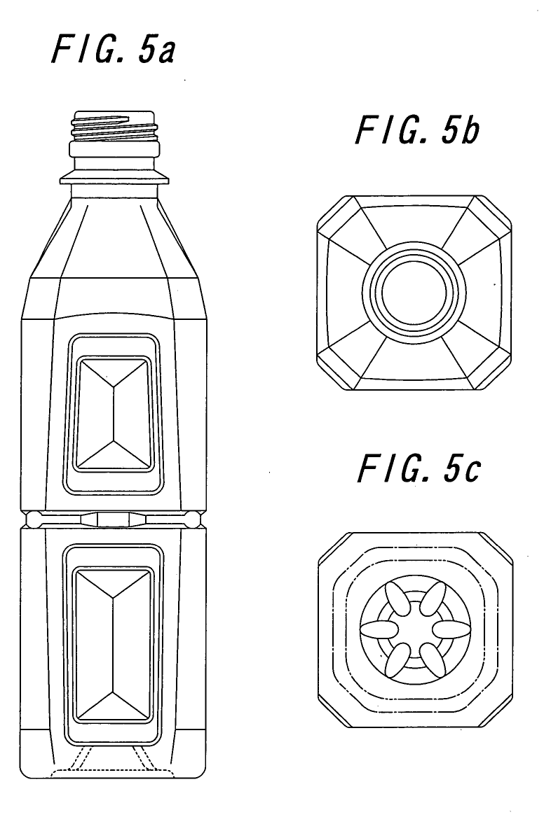

Heat resistant bottles (350 milliliters and 500 milliliters) having a square cross-section, as shown in FIGS. 5a through 5c, were made by a single blow molding using a preform comprising PET resin alone, and by a double blow molding using a preform in which PET resin is blended with a barrier material, as a basis for comparison. With respect to the bottles obtained by the respective blow moldings, oxygen permeation amount, oxygen permeation index and shelf lives were measured, the result of which is shown in Tables 1 and 2 below.

Single blow molding conditions

| | | |
|---|---|---|
| Mold temperature (main body): | 110° | C. |
| Blowing pressure: | 3.92 | Mpa |
| Stretching speed: | 42 | cm/s |
| Double blow molding conditions | | |

(First bi-axial stretch blow molding)

| | | |
|---|---|---|
| Mold temperature (main body): | 165° | C. |
| Blowing pressure: | 2.35 | Mpa |
| Stretching speed: | 40 | cm/s |

(Second bi-axial stretch blow molding)

| | | |
|---|---|---|
| Mold temperature (main body): | 104° | C. |
| Blowing pressure: | 3.92 | Mpa |

TABLE 1
(350 milliliters square-section bottle)

| | | Oxygen | Oxygen | | |
|---|---|---|---|---|---|
| | | permeation | permeation | | |
| Blow | | amount | index (1 = | Shelf | |
| molding | Material | (cc/day) | PET alone) | life | Remarks |
| Single | PET alone | 0.031 | 1 | 1 | Reference |
| Single | PET + MXD-6 | 0.026 | 0.84 | ×1.19 | Reference |
| | (2 mass % | | | | |
| | blend) | | | | |
| Single | PET + MXD-6 | 0.022 | 0.71 | ×1.41 | Reference |
| | (4 mass % | | | | |
| | blend) | | | | |
| Double | PET alone | 0.021 | 0.68 | ×1.48 | Reference |
| Double | PET + MXD-6 | 0.018 | 0.58 | ×1.72 | Reference |
| | (2 mass % | | | | |
| | blend) | | | | |
| Double | PET + MXD-6 | 0.013 | 0.42 | ×2.38 | Invention |
| | (4 mass % | | | | |
| | blend) | | | | |

TABLE 2
(500 milliliters square-section bottle)

| | | Oxygen | Oxygen | | |
|---|---|---|---|---|---|
| | | permeation | permeation | | |
| Blow | | amount | index (1 = | Shelf | |
| molding | Material | (cc/day) | PET alone) | life | Remarks |
| Single | PET alone | 0.038 | 1 | 1 | Reference |
| Single | PET + MXD-6 | 0.031 | 0.81 | ×1.23 | Reference |
| | (2 mass % | | | | |
| | blend) | | | | |
| Single | PET + MXD-6 | 0.026 | 0.68 | ×1.48 | Reference |
| | (5 mass % | | | | |
| | blend) | | | | |
| Double | PET alone | 0.027 | 0.71 | ×1.41 | Reference |
| Double | PET + MXD-6 | 0.024 | 0.63 | ×1.58 | Invention |
| | (2 mass % | | | | |
| | blend) | | | | |
| Double | PET + MXD-6 | 0.02 | 0.53 | ×1.90 | Invention |
| | (5 mass % | | | | |
| | blend) | | | | |

As can be seen from Tables 1 and 2 above, it has been confirmed that the container according to the present invention makes it possible to markedly lower the oxygen permeation amount and significantly prolong the shelf life of the merchandise.

Moreover, in connection with the heat resistance, while the container produced by the single blow molding gave rise to shape deformation at the temperature of the contents of about 85-87° C., the container according to the present invention has a significantly improved heat resistance in that shape deformation does not occur up to the temperature of about 90-93° C.

It will be appreciated from the foregoing description that, according to the present invention, improvement can be achieved not only in the heat resistance, but also in the gas barrier property, thereby making it possible to enlarge the applicable scope of the container and/or to maintain the quality of the contents for a longer period.

It is needless to mention that the present invention is not limited to the above-described embodiment, and various changes or modifications may be made.

1. A synthetic resin container having excellent gas barrier property and heat resistance, wherein said container comprises a matrix that is blended with a gas barrier material, and wherein said container is produced by a process including bi-axial stretch blow molding steps performed at least twice, with a heat treatment step therebetween.

2. A synthetic resin container according to claim 1, wherein said matrix comprises polyethylene terephthalate resin, and said gas barrier material comprises at least one member selected from a group consisting of a methaxylylene group-containing polyamide resin, an amorphous polyester resin and an ethylene naphthalate-ethylene terephthalate copolymer resin.

3. A multi-layered synthetic resin container having excellent gas barrier property and heat resistance, wherein said container comprises a base layer having a matrix that is blended with a gas barrier material, and a protection layer having an enriched gas barrier property, and wherein said container is produced by a process including bi-axial stretch blow molding steps performed at least twice, with a heat treatment step therebetween.

4. A synthetic resin container according to claim 3, wherein said matrix comprises polyethylene terephthalate resin, and said gas barrier material comprises at least one member selected from a group consisting of a methaxylylene group-containing polyamide resin, an amorphous polyester resin and an ethylene naphthalate-ethylene terephthalate copolymer resin.

5. A synthetic resin container according to claim 3, wherein said protection layer comprises at least one member selected from a group consisting of a methaxylylene group-containing polyamide resin, an amorphous polyester resin, an ethylene naphthalate-ethylene terephthalate copolymer resin and an ethylene-vinyl alcohol copolymer resin.

6. A method for producing a synthetic resin container having excellent gas barrier property and heat resistance, by bi-axial stretch blow molding steps performed at least twice, with a heat treatment step therebetween, wherein said blow molding steps are performed with a preform consisting of a synthetic resin of which a matrix is blended with a gas barrier material.

7. A method according to claim 6, wherein said preform comprises a multi-layered structural body comprising a base layer having a matrix that is blended with a gas barrier material, and a protection layer having an enriched gas barrier property.
